(19) United States
(12) Patent Application Publication
(10) Pub. No.: US 2012/0027932 A1
(43) Pub. Date: Feb. 2, 2012

(54) SLIDE COATING DEVICE, COATING METHOD USING THE DEVICE, AND METHOD FOR MANUFACTURING OPTICAL FILM USING THE METHOD

(76) Inventors: Satoshi KUNIYASU, Minami-Ashigara-shi (JP); Tamotsu Saikawa, Minami-Ashigara-shi (JP)

(21) Appl. No.: 13/191,838

(22) Filed: Jul. 27, 2011

(30) Foreign Application Priority Data
Jul. 28, 2010 (JP) 2010-169567

(51) Int. Cl. B05D 5/06; B05D 1/30

(52) U.S. Cl. 427/162; 118/407

(57) ABSTRACT

The present invention provides a method for manufacturing an optical film which is superior in transportability and lamination suitability in a lamination step in a polarizing plate processing. A slide coating device includes applying one or more coating liquids flowing down on a slide face to the surface of a continuously traveling strip-shaped support through the bead of the coating liquids, which is formed by the coating liquids in a lip clearance formed between a lip tip in the lower end of the slide face and the surface of the support, and also having guide plates on both ends of the slide face, which guide the downflow of the coating liquids, wherein the guide plates are provided so that the lower ends of the guide plates are retracted from the lip tip by the range of more than 0 mm and less than 4 mm.

### BACKGROUND OF THE INVENTION

1. Field of the Invention

The present invention relates to a slide coating device, a coating method using the device, and a method for manufacturing an optical film using the method, and particularly relates to the slide coating device which has guide plates provided on both ends of a slide face of a slide coating hopper so that the guide plates guide a coating liquid flowing down on the slide face, the coating method using the device, and the method for manufacturing the optical film using the method.

2. Description of the Related Art

When the coating liquid is applied to a continuously-traveling strip-shaped support (hereafter referred to as a web as well) by using a slide coating device, the slide coating device has guide plates arranged on both ends of a slide face on which a coating liquid flows down. This guide plate has a role of stably guiding the coating liquid to be applied onto the web down to a lip tip at the nose of the slide face, by making the liquid contact surface touch the both ends of the coating liquid which flows down the slide face.

Japanese Patent Application Laid-Open No. 5-4065 discloses a slide bead coating device having a guide plate provided thereon which enables a liquid to be stably applied even when the liquid is applied at a high speed to form a thin film. The coating device further has flexible pieces which approach or come in contact with the support from the both ends (lip tips) in the width direction of the leading edge of a dice.

In addition, Japanese Patent Application Laid-Open No. 2005-58922 discloses a slide bead coating device which can prevent not only a thick coating and the edge irregularity in the width ends of a coating film, but also the thick coating in the inside of the end due to a contracted flow. In the coating device, the nose parts of the guide plates are formed from a hydrophilic material having high wettability, and the rear end parts of the guide plates are formed from a water-repellent material having low wettability.

Furthermore, Japanese Patent Application Laid-Open No. 2000-262948 discloses a slide bead coating device which prevents a neck-in phenomenon and a thick film by applying a high-viscosity liquid while supplying an auxiliary liquid having a low viscosity to the both ends of the slide face.

### SUMMARY OF THE INVENTION

However, even by using the slide bead coating device in Japanese Patent Application Laid-Open No. 5-4065, Japanese Patent Application Laid-Open No. 2005-58922 and Japanese Patent Application Laid-Open No. 2000-262948, such a problem occurred that a thick coating was formed on an end of a coating film, when a coating liquid having a low viscosity was applied. In addition, such a problem occurred in some cases that a streak appears on width ends of a coating film.

The present invention is designed with respect to such a circumstance, and the objects are to provide a slide coating device which can prevent a thick coating from being formed on ends of a coating film and prevent a streak from appearing on the ends of the coating film and to provide a coating method using the device.

In order to achieve the above described object, a first aspect of the present invention provides a slide coating device which applies one or more coating liquids flowing down on a face of a slide to a surface of a continuously-traveling strip-shaped support through a bead of the coating liquids, the bead formed by the coating liquids in a lip clearance between a lip tip in a lower end of the face of the slide and the surface of the support, the slide coating device comprising: the slide; and guide plates arranged on both ends of the face of the slide, the guide plates which guide the downflow of the coating liquids and are provided in a manner that lower ends of the guide plates are retracted from the lip tip by a range of more than 0 mm and less than 4 mm.

In order to achieve the above described objects, a second aspect of the present invention also provides a slide coating method, including applying a coating liquid by using the slide coating device according to the first aspect.

Conventionally, guide plates have been provided on both ends on a face of the slide in order to guide the downflow of a coating liquid and prevent the coating liquid from spreading toward a width direction. The purpose of preventing the spread of the coating liquid toward the width direction is to prevent the coating liquid from flowing to a rear face of the support to be applied, and accordingly it has been commonly accepted that the guide plates cover the both ends at least down to the lip tip in the lower end of the face of the slide.

However, if the coating liquid having a low viscosity has been used, when the liquid flows on the face of the slide to form a bead between a lip and a support, the coating liquid becomes to easily flow not only toward a transporting direction of the support (machine direction: MD) but also toward a clearance direction (CD), the clearance formed between the lip and the support. As a result, the ends of the coating film spread beyond the regulation width formed by the guide plates, which has caused an application failure such as thick coating and streaks (edge tear).

As a result of an extensive investigation, the inventors have found out that the above described application failure arises from a structure in which the guide plates were provided so as to come close to the support by a distance equal to the application clearance (coating clearance). The inventors have found that when both of the guide plates and the support approached each other, a liquid which traveled along the guide plates flowed into the gap (clearance) due to the capillary force and spread farther than the regulation width. In other words, the coating liquid having a low viscosity cannot be applied uniformly in the width direction, with the method of covering the guide plates down to the lip tip or projecting the noses of the guide plates more closely toward the support than the lip tip in Japanese Patent Application Laid-Open No. 5-4065.

Then, the present inventors determined to provide the guide plates in a manner that the lower ends of the guide plates become shorter than (are retracted from) the lip tip by the range of more than 0 mm and less than 4 mm, in order to prevent a thick coating from being formed on the ends of a coating film and prevent a streak from appearing on the ends of the coating film.

A second aspect of the present invention can provide a coating method using the slide coating device which can prevent the thick coating from being formed in the ends of the coating film and prevent the streak from appearing in the ends of the coating film.

The present invention shows the effect particularly when a viscosity of the coating liquid is less than 10 mPa·s. This is because when the viscosity of the coating liquid is 10 mPa·s or more, the present invention can suppress the problems of thick coating and formation of the streak on the ends of the coating film due to the wetting and spreading of the coating liquid in a conventional type of coating device such as in Japanese Patent Application Laid-Open No. 5-4065 or Japanese Patent Application Laid-Open No. 2005-58922.

The present invention shows the effect particularly when a total thickness of coating film formed of coating liquids is 40 g/m² or less. Here, the total thickness of the coating film of the coating liquids means, when a plurality of coating liquids are overlaid, the sum of all the film thicknesses of coating films overlaid, and the total thickness of the applied wet coating films on the face of the slide. This is because when the total thickness of the coating films of the coating liquids is much thick, even if there is a thick coating to some extent on ends in the width direction, the thick coating does not cause a problem in the product in many cases. In contrast to this, when the total thickness of the coating films of the coating liquids is thin, the thick coating part on the ends become fatal in many products.

In addition, the present invention shows the effect particularly when a traveling speed of the support is 50 m/min or less. When the total thickness of the coating films of the coating liquids is supposed to be constant and a traveling speed of the support is supposed to be small, the force of pulling the coating liquid toward a transporting direction by a support becomes small. Then, a capillary force which makes the coating liquid spread and moisten the gap between the guide plates and the support relatively comes to greatly work, and the thick coating on the ends tends to be aggravated. Accordingly, as the traveling speed of the support becomes small, the necessity for the present invention increases.

An optical film manufactured by applying coating liquids with the slide coating method according to the present invention can have ends of a coating film prevented from having the thick coating and prevented from developing the streak.

The present invention can provide a slide coating device which can prevent the thick coating from being formed in both ends of the coating film and prevent the streak from appearing in the ends of the coating film; a coating method using the device, and a method for manufacturing an optical film using the method.

### BRIEF DESCRIPTION OF THE DRAWINGS

FIG. 1 is a side sectional view of a slide coating device according to the present embodiment;

FIG. 2 is a perspective view illustrating a slide coating hopper;

FIG. 3 is a top plan view of a slide coating device according to the present embodiment;

FIG. 4 is a graph showing a result of having investigated the thickness of a coating film, while changing the position of the lower end of a guide plate; and

FIGS. 5A and 5B are tables showing the conditions and results of the examples.

### DETAILED DESCRIPTION OF THE PREFERRED EMBODIMENTS

An embodiment of the present invention will be described below in detail. However, the present invention is not limited to the embodiment described here.

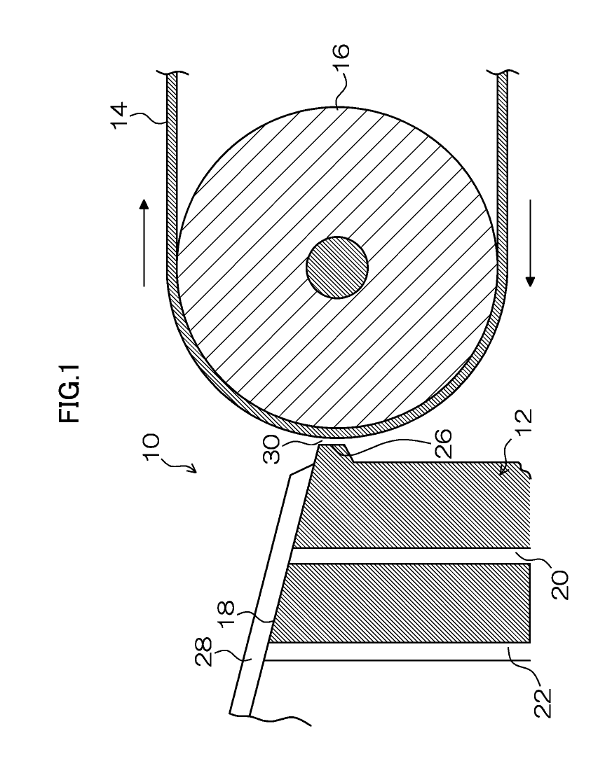

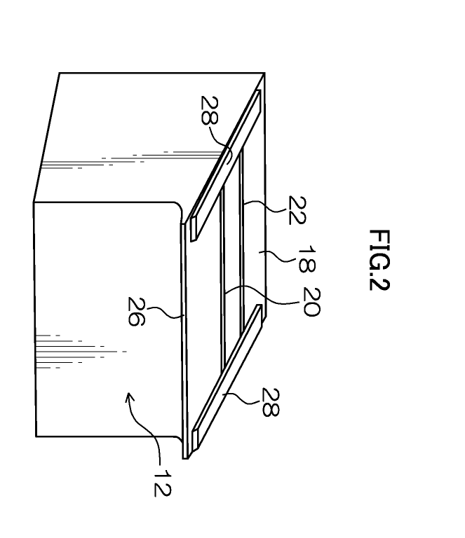

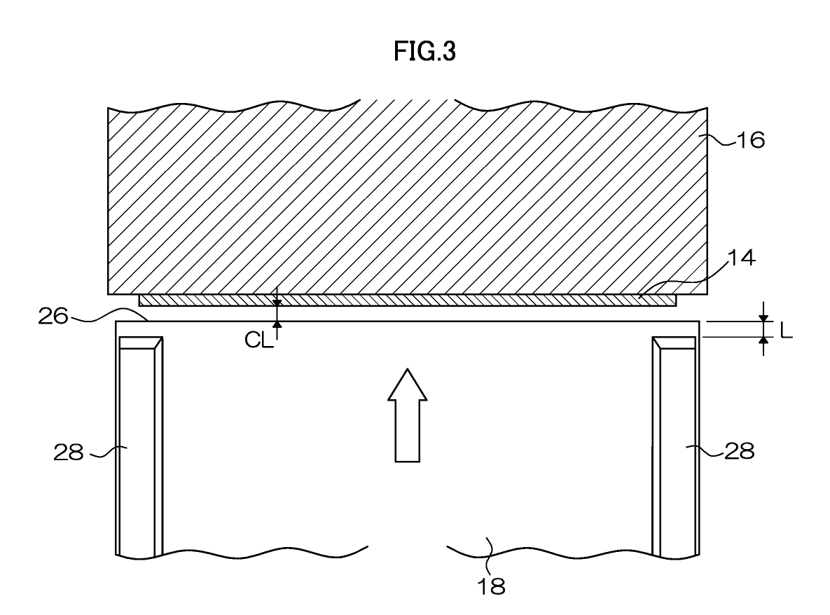

FIG. 1 is a side sectional view of a slide coating device 10 according to the present embodiment, FIG. 2 is a perspective view illustrating a slide coating hopper 12, and FIG. 3 is a top plan view of the slide coating device 10 according to the present embodiment. Incidentally, an example of a bilayer application of a lower-layer coating liquid L1 which comes in contact with a web (support) 14 and an upper-layer coating liquid L2 will be described below, as one example of a multilayer slide bead application, but the present invention can include one-layer coating and three or more layer coating.

As illustrated in FIG. 1 to FIG. 3, the slide coating device 10 mainly includes the slide coating hopper 12 and a backup roller 16 which makes the web 14 travel continuously. The slide coating hopper 12 has a slide face 18 which tilts downward toward the side of the backup roller 16 formed on the upper surface of the slide coating hopper 12, and the slide face 18 has slim exhaust ports of two slits 20 and 22 formed in parallel thereunder. These two slits 20 and 22 shall be referred to as the first slit 20 for a lower-layer coating liquid L1 and the second slit 22 for an upper-layer coating liquid L2, from a downstream side in a flow direction of the coating liquids.

The coating liquids L1 and L2 are extruded onto the slide face 18 through the respective slits 20 and 22. The respective coating liquids L1 and L2 which have been extruded onto the slide face 18 are successively overlaid while flowing down on the slide face 18, form a multilayer coating liquid, and reach a lip tip 26 of the lower end of the slide face 18 without being mixed with each other. The downflow (falling) of the coating liquid on the slide face 18 is guided by a pair of guide plates 28 and 28 arranged in parallel on the both ends on the slide face 18. The coating liquid which has reached the lip tip 26 forms a coating liquid bead in a gap 30 between the lip tip 26 and the surface of the traveling web 14 which is wound around the backup roller 16, and is applied onto the surface of the web 14 through this coating liquid bead.

Various types of liquid compositions can be considered for the coating liquids L1 and L2 according to the use of an optical film, and for instance, a combination of a coating liquid which forms a hard coat layer and a coating liquid which forms an electroconductive hard coat layer can be considered.

The web to be used in the present embodiment includes paper, a plastic film, metal, a resin-coated paper and a synthetic paper. Materials of the plastic film, for instance, include: a polyolefin such as polyethylene and polypropylene; a vinyl polymer such as polyvinyl acetate, polyvinyl chloride, polystyrene; a polyamide such as 6,6-nylon and 6-nylon; a polyester such as polyethylene terephthalate and polyethylene-2,6-naphthalate; and a cellulose acetate such as polycarbonate, cellulose triacetate and cellulose diacetate. In addition, a resin to be used for the resin-coated paper is typically a polyolefin including polyethylene, but is not necessarily limited to the polyolefin. Furthermore, a metal web includes, for instance, an aluminium web.

The coating liquids L1 and L2 having been extruded onto the slide face 18 from the slits 20 and 22 are overlaid while being guided by the guide plate 28 and flowing down on the slide face 18, and form the multilayer coating liquid. The coating liquid gets wet and spreads toward the guide plate 28, and because of this, the coating liquid layer becomes thick in both end faces which come in contact with the guide plates 28. In the present embodiment, when forming such a multilayer coating liquid, the guide plates 28 are provided so that the lower ends of the guide plates become shorter than the lip tip by the range of more than 0 mm and less than 4 mm.

In order to guide the downflow of the coating liquid and prevent the coating liquid from spreading toward the width direction, the guide plates have been conventionally provided on both ends on the slide face. The purpose of preventing the spread of the coating liquid toward the width direction is to prevent the coating liquid from flowing to the rear face of the support to be coated, and accordingly it has been commonly accepted that the guide plates cover the both ends to reach at least down to the lip tip of the lower end of the slide face.

However, in the present embodiment, the guide plates is configured so that the lower ends of the guide plates become shorter than the lip tip by the range of more than 0 mm and less than 4 mm, in order to prevent a thick coating from being formed in both width ends of a coating film and prevent a streak from appearing in the both width ends of the coating film. In other words, the guide plates 28 are made to retract so that the distance L between the lower ends of the guide plates 28 and the lip tip 26 come into the range of more than 0 mm and less than 4 mm, which is illustrated in FIG. 3.

Thereby, it is enabled to prevent the thick coating from being formed in the width ends of the coating film and prevent the streak from appearing in the width ends of the coating film.

An optical film which has been applied and manufactured by the slide coating device according to the present embodiment can prevent the thick coating from being formed in the width ends of the coating film and prevent the streak from appearing in the width ends of the coating film.

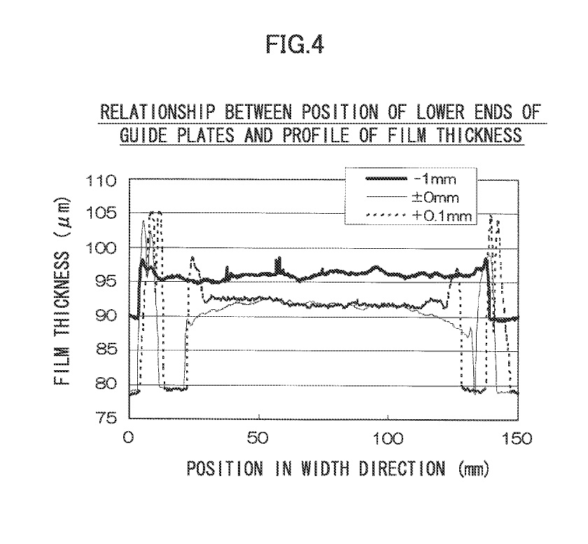

FIG. 4 is a graph showing a result of having investigated the thicknesses of coating films, while changing the position of the lower end of the guide plate. The experiments were carried out on conditions of, using the coating liquid having a viscosity of 7.5 mPa·s as one-layer coating and the application width being fixed to 130 mm. In addition, the experiments were carried out on conditions of: having the position of the lower ends of the guide plates retracted from the lip tip; having the position of the lower ends of the guide plates matched with that of the lip tip; and having the position of the lower ends of the guide plates projected from the lip tip. For information, at this time, the retracted length and the projected length were respectively set at 1 mm and 0.1 mm.

As is understood from the graph in FIG. 4, the thick coating (edge rise) can be prevented from being formed on the end of the coating film by the structure in which the lower end of the guide plates are retracted from the lip tip. Accordingly, even when an optical film which has passed a drying and curing process is wound up to form a roll shape afterward, wrinkles appearing on the roll can be prevented by the structure for reducing the edge rise on the optical film, and an optical film of high quality can be provided.

In addition, after the coating liquid has been applied onto the web, the optical film according to the present embodiment is preferably transported in the form of the web to a heated zone to dry the solvent.

Various kinds of information can be used for a method of drying the solvent. Specific information includes Japanese Patent Application Laid-Open No. 2001-286817, Japanese Patent Application Laid-Open No. 2001-314798, Japanese Patent Application Laid-Open No. 2003-126768, Japanese Patent Application Laid-Open No. 2003-315505, Japanese Patent Application Laid-Open No. 2004-34002. The temperature in a drying zone is preferably set at 25° C. to 140° C., the temperature in the first half of the drying zone is preferably set relatively low, and the temperature in the latter half of the drying zone is preferably set relatively high. However, the temperatures are preferably not higher than a temperature at which components contained in a coating composition of each layer except the solvent start volatilization. For instance, in commercially-available radical-photogenerating agents which are concomitantly used with an ultraviolet curing resin, there is one in which about several tens of percentages of the composition volatilize within several minutes in the warm air at 120° C., and in monofunctional or bifunctional acrylate monomers, there is one in which the volatilization progresses in the warm air at 100° C. In such a case, as described above, the temperature in the drying zone is preferably not higher than the temperature at which components contained in an application composition of each layer except the solvent start volatilization.

In addition, as for the drying wind to be supplied after the coating liquid has been applied onto the web, the wind speed on the surface of the coating film is preferably in the range of 0.1 to 2 m/sec while the solid concentration of the application composition is 1 to 50%, in order to prevent the unevenness of drying.

Furthermore, after the coating liquid has been applied onto the web, a difference between temperatures of the transportation roll which comes in contact with the reverse face of the liquid-applied face of the support in the drying zone and the support is preferably set in the range of 0° C. to 20° C., because the unevenness of drying due to the unevenness of heat transfer on the transportation roll can be prevented.

After the solvent has been dried, the optical film according to the present embodiment is passed in the form of the web through the zone in which each coating film is cured by ionizing radiation and/or heat, and the coating film is cured there. The type of ionizing radiation in the present invention is not particularly limited, but can be appropriately selected from ultraviolet light, an electron beam, near-ultraviolet light, visible light, near-infrared light, infrared light, X-rays and the like, according to the type of the curable composition which forms the film. Among them, the ultraviolet light and the electron beam are preferable, and the ultraviolet light is particularly preferable at the point that handling is easy and high energy can be easily obtained.

Any light source can be used as a light source of the ultraviolet light for photopolymerizing an ultraviolet reactive compound as long as the light source generates the ultraviolet light. Usable light sources include, for instance, a low-pressure mercury lamp, a medium-pressure mercury lamp, a high-pressure mercury lamp, an ultrahigh-pressure mercury lamp, a carbon-arc lamp, a metal halide lamp and a xenon lamp. The usable light sources include also an ArF excimer laser, a KrF excimer laser, an excimer lamp and synchrotron radiation. Among the light sources, preferably usable light sources are the ultrahigh-pressure mercury lamp, the high-pressure mercury lamp, the low-pressure mercury lamp, the carbon arc lamp, the xenon arc lamp and the metal halide lamp.

In addition, the electron beam can also be used similarly. The electron beam can include an electron beam which is emitted from a wide variety of electron beam accelerators such as a Cockcroft-Walton type, a Van de Graaff type, a resonance transformation type, an insulation core transformer type, a linear type, a dynamitron type and a high-frequency type, and has an energy of 50 to 1,000 keV and preferably of 100 to 300 keV.

The irradiation condition varies depending on each lamp, but the amount of light irradiation is preferably 10 mJ/cm² or more, further preferably is 50 mJ/cm² to 10,000 mJ/cm², and particularly preferably is 50 mJ/cm² to 2,000 mJ/cm². At this time, a distribution of the amount of irradiation in the width direction of the web is preferably 50 to 100% with respect to the maximum amount of irradiation in the center when including the both ends, and more preferably is 80 to 100%. In the present embodiment, it is preferable to cure a hard coat layer and an electroconductive hard coat layer on the web by a process of irradiating the layers with the ionizing radiation in an atmosphere having a oxygen concentration of 1,000 ppm or less, preferably of 500 ppm or less, further preferably of 100 ppm or less and most preferably of 50 ppm or less, in a state where the film is heated to have a surface temperature 50° C. or higher for 0.5 seconds or longer from the time when the irradiation with the ionizing radiation is started.

It is also preferable to heat the layers in an atmosphere having a low oxygen concentration simultaneously and/or continuously with irradiation with the ionizing radiation.

A period of time for irradiating the layers with the ionizing radiation is preferably 0.7 seconds or longer and 60 seconds or shorter, and more preferably is 0.7 seconds or longer and 10 seconds or shorter. When the period of time is 0.5 seconds or shorter, a curing reaction cannot be completed and the layers cannot be sufficiently cured. On the other hand, it is not preferable to keep the condition of the low oxygen concentration for a long period of time, because a large facility and a large amount of an inactive gas are needed.

As for the technique of controlling the oxygen concentration to 1,000 ppm or less, it is preferable to replace the atmosphere with another gas, and particularly preferable to replace the atmosphere with nitrogen (nitrogen purge).

An inactive gas may be supplied to a chamber for irradiation with the ionizing radiation (also referred to as “reaction chamber”), in which the curing reaction by the ionizing radiation proceeds, and set to a condition that the inactive gas blows out toward the entrance side of the web in the reaction chamber. Thereby, it is possible to eliminate the air carried together with a transported web, effectively lower the oxygen concentration in a reaction chamber and efficiently decrease the substantive oxygen concentration on the extreme surface in which curing is greatly obstructed by oxygen. The flow direction of the inactive gas in the entrance side of the web in the reaction chamber can be controlled by adjusting the balance between gas supply and exhaust in the reaction chamber.

It is also preferably used as a method of eliminating the carried air to spray an inactive gas directly onto the surface of the web.

It can also more efficiently proceed curing to provide a front chamber in front of the above described reaction chamber and eliminate oxygen on the surface of the web in advance. In addition, it is preferable to set the gap between a side face constituting the entrance side of the web in the ionizing radiation reaction chamber or the front chamber and the surface of the web preferably at 0.2 to 15 mm, more preferably at 0.2 to 10 mm, and most preferably at 0.2 to 5 mm, so as to efficiently use the inactive gas.

### Example

Next, an example of a slide coating device 10 according to the present embodiment will be described below.

The structure of the slide coating hopper 12 is similar to that illustrated in FIG. 1 to FIG. 3.

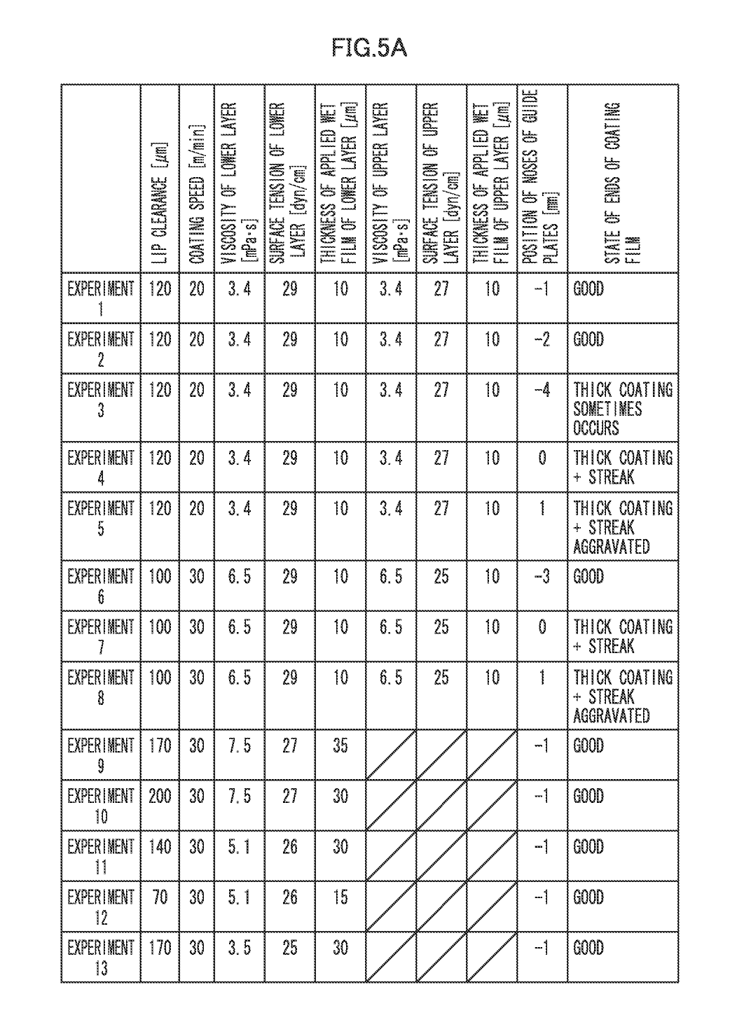

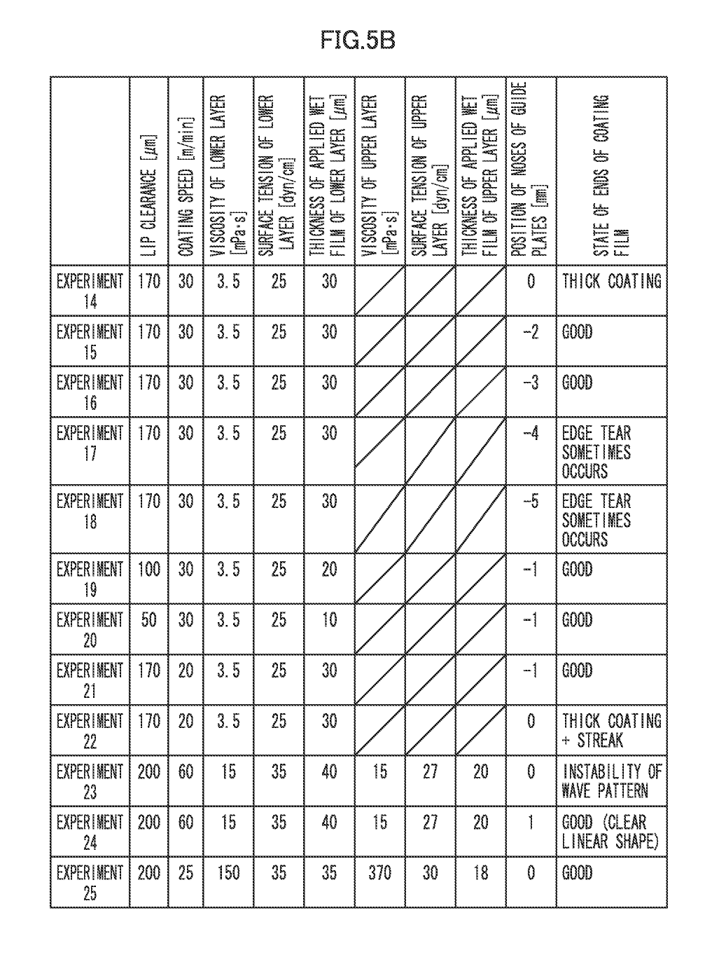

As shown in tables of FIGS. 5A and 5B, the coating liquid was applied onto the web with the slide coating device 10 while changing a clearance CL between the lip tip 26 and the face of the web 14 in the range of 50 μm to 200 μm, and changing the coating speed in the range of 20 m/min to 60 m/min. Then, the coating liquid having the viscosity and surface tension shown in the tables of FIGS. 5A and 5B was extruded onto the slide face 18 through the slits 20 and 22 so that the coating film had the thickness shown in the table. For information, when only the lower layer was applied in the tables of FIGS. 5A and 5B, the slit 22 was not used.

Here, an experiment was carried out while changing the position of the noses (lower ends) of the guide plates 28. An experiment in which the position of the lower ends of the guide plates was retracted from the lip tip is described by minus (−), an experiment in which the position of the lower ends of the guide plates was matched with the lip tip is described by zero (0), and an experiment in which the position of the lower ends of the guide plates was projected from the lip tip is described by plus (+).

Here, the end of the coating film was evaluated with a contact-type continuous thicknessmeter.

It is understood from this evaluation that the thick coating can be prevented from being formed on the ends of the coating film and a streak can be prevented from appearing on the ends of the coating film, by making the lower ends of the guide plates shorter than the lip tip by the range of more than 0 mm and less than 4 mm.

What is claimed is:

1. A slide coating device which applies one or more coating liquids flowing down on a face of a slide to a surface of a continuously-traveling strip-shaped support through a bead of the coating liquids, the bead formed by the coating liquids in a lip clearance between a lip tip in a lower end of the face of the slide and the surface of the support, the slide coating device comprising:
the slide; and
guide plates arranged on both ends of the face of the slide, the guide plates which guide the downflow of the coating liquids and are provided in a manner that lower ends of the guide plates are retracted from the lip tip by a range of more than 0 mm and less than 4 mm.

2. A slide coating method comprising applying a coating liquid by using the slide coating device according to claim 1.

3. The slide coating method according to claim 2, wherein a viscosity of the coating liquid is less than 10 mPa·s.

4. The slide coating method according to claim 3, wherein a total thickness of coating film formed of the coating liquids is 40 g/m² or less.

5. The slide coating method according to claim 3, wherein a traveling speed of the strip-shaped support is 50 m/min or less.

6. A method for manufacturing an optical film on which a coating liquid has been applied with the slide coating method according to claim 2.
